(19) United States
(12) Patent Application Publication
(10) Pub. No.: US 2020/0181955 A1
(43) Pub. Date: Jun. 11, 2020

(54) RETAINING LATCH, CLOSURE CONFIGURATION, CONTAINER AND RAIL VEHICLE

(71) Applicant: Siemens Mobility GmbH, Muenchen (DE)

(72) Inventor: CHRISTIAN NITZSCHE, Ismaning (DE)

(21) Appl. No.: 16/704,131

(22) Filed: Dec. 5, 2019

(30) Foreign Application Priority Data
Dec. 5, 2018 (DE) 102018221050

(51) Int. Cl. E05C 3/04; E05B 15/14; E05B 63/00

(52) U.S. Cl. CPC E05C 3/042; E05B 63/0034; E05B 15/14

(57) ABSTRACT

A retaining latch includes a rotary limb with an eyelet at one end. The retaining latch also has a latch limb which runs perpendicularly with respect to the rotary limb. The latch limb has a locking face disposed on the end side of the latch limb and a stop face running parallel to the axial direction of the latch limb. A closure configuration, a container and a rail vehicle are also provided.

### CROSS-REFERENCE TO RELATED APPLICATION

This application claims the priority under 35 U.S.C. § 119, of German Patent Application DE 10 2018 221 050.0, filed Dec. 5, 2018; the prior application is herewith incorporated by reference in its entirety.

### BACKGROUND OF THE INVENTION

### Field of the Invention

The invention relates to a retaining latch. Furthermore, the invention relates to a closure configuration. Moreover, the invention relates to a container. In addition, the invention relates to a rail vehicle.

Equipment carriers, for example in rail vehicles, but also containers or electric switching cabinets, have to be opened regularly. There is the risk in that case that flaps, doors or covers are not closed properly. The cause can lie in the fact that the retaining latches swivel-in in front of the retaining brackets provided for that purpose and therefore do not hook-in. It therefore cannot be visually detected from the outside beyond doubt whether or not the flap, the doors or the cover have been closed. Even the features which are provided for that purpose on compression and latch closures by the closure manufacturers cannot indicate that unambiguously. As a result, it can occur in the worst case that a flap of that type, a door or a cover of that type opens, and a collision with the infrastructure is caused by way of equipment which falls out or (in the case of a drawer system) extends out.

If standard retaining latches of that type are used, only special care of the service staff helps. In that case, a special, separate check of the flaps, doors or covers has to take place by way of testing by pulling, in order to guarantee the proper closure.

### SUMMARY OF THE INVENTION

It is accordingly an object of the invention to provide a retaining latch, a closure configuration, a container and a rail vehicle, which overcome the hereinafore-mentioned disadvantages of the heretofore-known devices of this general type and by way of which high safety of the closing state of containers of rail vehicles can be achieved by way of flaps, doors or covers.

With the foregoing and other objects in view there is provided, in accordance with the invention, a retaining latch including a rotary limb with an eyelet at one end. The rotary limb is set up to corotate with a rotating lock of a pivotable opening cover. The lock can include, for example, a compression lock or a rotary latch lock. The pivotable opening cover can include, for example, a door, a cover or a flap. Moreover, the retaining latch according to the invention has a locking face which is disposed on the end side of the latch limb. In other words, the locking face runs perpendicularly with respect to the longitudinal direction of the latch limb. Moreover, the latch limb has a stop face which runs parallel to the longitudinal direction of the latch limb and is preferably disposed laterally. In the case of a closing movement of the lock with a correct position of the pivotable opening cover, the locking face engages behind a retaining bracket, with the result that the pivotable opening cover cannot open without an actuation of the lock. The retaining bracket can be fastened, for example, to an inner side of a housing or container, the pivotable opening cover of which is closed with the aid of the retaining latch. The retaining latch comes into contact by way of the stop face with the retaining bracket when the lock is actuated in the case of a half open pivotable opening cover. In this way, the maintenance staff notices that the door position is incorrect and closes the pivotable opening cover before the lock is actuated, in order to carry out a closing operation. An increased reliability of the closed state of containers, in particular in the case of rail vehicles, is advantageously achieved.

With the objects of the invention in view, there is also provided a closure configuration including a compression or rotary closure of a pivotable opening cover, a retaining bracket and a retaining latch according to the invention. The retaining latch is fixed by way of its eyelet on the compression or rotary closure. The retaining bracket is positioned in such a way that, in the case of a closing movement of the retaining latch in the correctly closed state of the pivotable opening cover, the locking face engages behind the retaining bracket, and, in the case of a closing movement of the retaining latch in the incorrectly closed state of the pivotable opening cover, the stop face bumps against the retaining bracket, with the result that the compression or rotary closure is blocked. In other words, in the latter case, the closing movement cannot be carried out completely, which alerts the person carrying out the closing operation to the fact that the pivotable opening cover is not closed correctly. The closure configuration according to the invention shares the advantages of the retaining latch according to the invention.

With the objects of the invention in view, there is additionally provided a container including an opening on its front side, and a pivotable opening cover. Furthermore, the container according to the invention has a closure configuration according to the invention. The container according to the invention shares the advantages of the retaining latch according to the invention.

With the objects of the invention in view, there is concomitantly provided a rail vehicle including a container according to the invention. The rail vehicle according to the invention shares the advantages of the retaining latch according to the invention.

Other features which are considered as characteristic for the invention are set forth in the appended claims. The dependent claims and the following description in each case contain particularly advantageous refinements and developments of the invention. In addition, the various features of different exemplary embodiments and claims can also be combined to form new exemplary embodiments too within the scope of the invention.

Although the invention is illustrated and described herein as embodied in a retaining latch, a closure configuration, a container and a rail vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, perspective view of an equipment carrier housing in accordance with one exemplary embodiment of the invention;

FIG. 2 is a fragmentary, perspective view of a rotary latch closure with a retaining latch in a blocking state in accordance with one exemplary embodiment of the invention; and

FIG. 3 is a perspective view of a retaining latch in accordance with one exemplary embodiment of the invention.

### DETAILED DESCRIPTION OF THE INVENTION

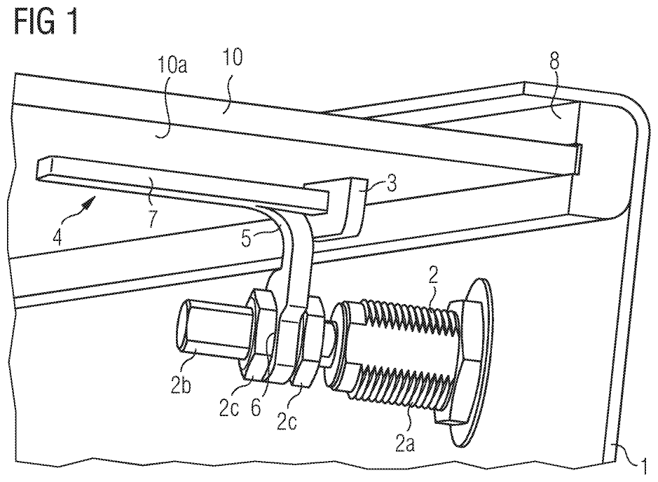

Referring now to the figures of the drawings in detail and first, particularly, to FIG. 1 thereof, there is seen a perspective view of an equipment carrier housing 10 in accordance with one exemplary embodiment of the invention. The equipment carrier housing 10 has a pivotable door 1, on which a rotary latch closure 2 is disposed. A retaining bracket 3 is disposed on the ceiling 10a of the housing 10. A retaining latch 4 in accordance with one exemplary embodiment of the invention is disposed on the rotary latch closure 2 or compression closure. The retaining latch 4 is disposed on a hexagonal extension 2b (equipped with a thread), with a thread and a rotary securing device of a rotary cylinder 2a of the rotary latch closure 2. The retaining latch 4 has a rotary limb 5. At its end which is disposed on the rotary latch closure 2, the rotary limb 5 includes an eyelet 6, through which the hexagonal extension 2b is guided. The eyelet 6 is locked on the hexagonal extension 2b with the aid of two nuts 2c. Furthermore, the retaining latch 4 has a latch limb 7 which runs perpendicularly with respect to the rotary limb 5. The latch limb 7 has a locking face 7a which runs perpendicularly with respect to the longitudinal direction of the latch limb 7 (see FIG. 3) and a stop face 7b which runs parallel to the longitudinal direction of the latch limb 7 (see FIG. 3).

FIG. 1 shows the equipment carrier housing 10 with a closed door 1 and in the locked state. In this case, the latch limb 7 passes behind the retaining bracket 3, with the result that blocking of the door 1 is achieved and opening of the door 1 is not possible without renewed rotating of the closure 2. A seal 8, which is disposed between the housing and the door 1, is also part of the equipment carrier housing 10. The basic function of the equipment carrier housing 10 can be realized even without a seal 8. The seal 8 prevents the penetration of moisture and dirt into the equipment carrier housing 10.

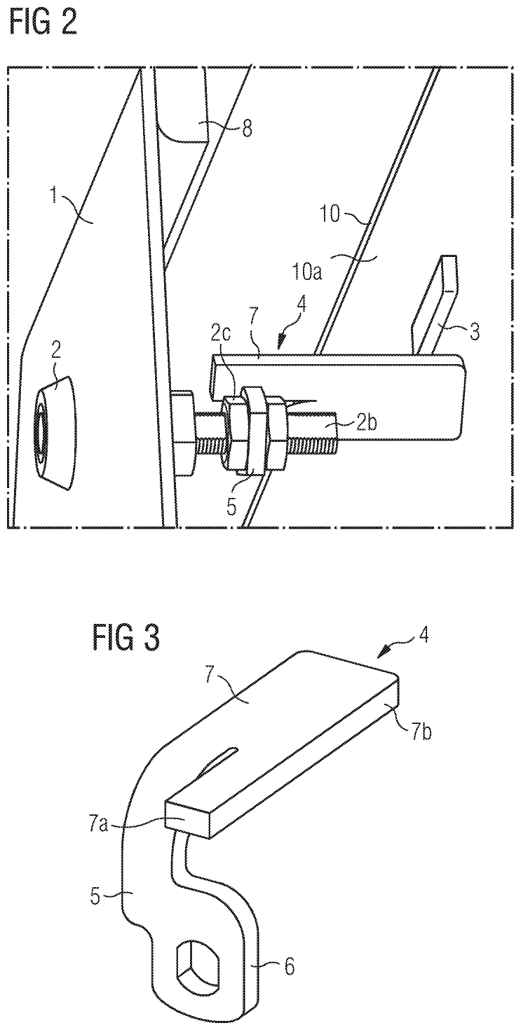

FIG. 2 shows a perspective illustration of a situation, in which the rotary latch closure 2 is actuated in the case of a slightly opened door 1 and the latch limb 7 of the retaining latch 4 bumps against the retaining bracket 3. A person carrying out the actuation notices the resistance and recognizes that the door cannot be closed properly.

FIG. 3 illustrates a perspective view of the retaining latch 4 which is shown in FIGS. 1 and 2. As has already been mentioned, the retaining latch 4 has a rotary limb 5. The rotary limb 5 includes an eyelet 6 at the end of the rotary limb 5 which is disposed on the rotary latch closure 2. Furthermore, the retaining latch 4 has a latch limb 7 which runs perpendicularly with respect to the rotary limb 5. A stop face 7b is situated on the latch limb 7 in a manner which runs on the narrow side of the latter in the longitudinal direction. The stop face 7b comes into contact with the retaining bracket 3 (see FIG. 2) in the case of an open door and in the case of a closing movement of the retaining latch. Furthermore, the end side of the latch limb 7 has a locking face 7a which bumps against the retaining bracket 3 in the closed state of the door after a closing movement of the retaining latch 4 (see FIG. 1).

Finally, it is once again noted that the above-described apparatuses are merely preferred exemplary embodiments of the invention, and that the invention can be varied by a person skilled in the art, without departing from the scope of the invention, in so far as it is specified by the claims. It is also noted for the sake of completeness that the use of the indefinite article “a” or “an” does not rule out it being possible for the relevant features to also be present multiple times.

1. A retaining latch, comprising:
a rotary limb having an end and an eyelet at said end; and
a latch limb running perpendicularly to said rotary limb, said latch limb having an end side, a longitudinal direction, a locking face disposed on said end side, and a stop face running parallel to said longitudinal direction.

2. A closure configuration, comprising:
a compression or rotary closure disposed on a pivotable opening cover having a correctly closed state and an incorrectly closed state;
a retaining latch including a rotary limb having an end and an eyelet at said end, said retaining latch being fixed with said eyelet on said compression or rotary closure;
said retaining latch including a latch limb running perpendicularly to said rotary limb, said latch limb having an end side, a longitudinal direction, a locking face disposed on said end side, and a stop face running parallel to said longitudinal direction;
a retaining bracket being positioned to cause said locking face to engage behind said retaining bracket, upon a closing movement of said retaining latch in said correctly closed state of the pivotable opening cover; and
said retaining bracket being positioned to cause said stop face to bump against said retaining bracket resulting in said compression or rotary closure being blocked, upon a closing movement of said retaining latch in said incorrectly closed state of the pivotable opening cover.

3. A container, comprising:
a front side of the container, said front side of the container having an opening;
a pivotable opening cover for closing said opening in a correctly closed state and an incorrectly closed state; and
a closure configuration including:
a compression or rotary closure disposed on said pivotable opening cover;
a retaining latch including a rotary limb having an end and an eyelet at said end, said retaining latch being fixed with said eyelet on said compression or rotary closure;
said retaining latch including a latch limb running perpendicularly to said rotary limb, said latch limb having an end side, a longitudinal direction, a locking face disposed on said end side, and a stop face running parallel to said longitudinal direction;
a retaining bracket being positioned to cause said locking face to engage behind said retaining bracket, upon a closing movement of said retaining latch in said correctly closed state of said pivotable opening cover; and
said retaining bracket being positioned to cause said stop face to bump against said retaining bracket resulting in said compression or rotary closure being blocked, upon a closing movement of said retaining latch in said incorrectly closed state of said pivotable opening cover.

4. A rail vehicle, comprising a container according to claim 3.
